(19) United States
(12) Patent Application Publication
(10) Pub. No.: US 2019/0391343 A1
(43) Pub. Date: Dec. 26, 2019

(54) OPTICAL CONNECTOR AND OPTICAL FIBER WITH CONNECTOR

(71) Applicants: SEI Optifrontier Co., Ltd., Yokohama-shi, Kanagawa (JP); SUMITOMO ELECTRIC INDUSTRIES, LTD., Osaka-shi, Osaka (JP)

(72) Inventors: Yohei AOSHIMA, Yokohama-shi, Kanagawa (JP); Tomoyuki YOKOKAWA, Yokohama-shi, Kanagawa (JP); Yuji SUZUKI, Yokohama-shi, Kanagawa (JP); Hiroyasu TOYOOKA, Yokohama-shi, Kanagawa (JP)

(73) Assignees: SEI Optifrontier Co., Ltd., Yokohama-shi, Kanagawa (JP); SUMITOMO ELECTRIC INDUSTRIES, LTD., Osaka-shi, Osaka (JP)

(21) Appl. No.: 16/481,577

(22) PCT Filed: Oct. 12, 2017
(86) PCT No.: PCT/JP2017/037050

§ 371 Date: Jul. 29, 2019

(30) Foreign Application Priority Data
Jan. 31, 2017 (JP) 2017-015978

(51) Int. Cl. G02B 6/38

(52) U.S. Cl. CPC G02B 6/3887; G02B 6/3825; G02B 6/387

(57) ABSTRACT

An optical connector includes a first housing and a second housing which is attached to a rear portion of the first housing in an attachable and detachable manner. The second housing includes a first latch portion and a second latch portion which extend from the rear portion toward the front portion so as to respectively engage with an adapter or a receptacle in a first connector inlet and a second connector inlet. The second housing is attachable to the rear portion in both of a state in which the first latch portion and the second latch portion are located on one side of the first housing in a third direction intersecting the first direction and the second direction and a state in which the first latch portion and the second latch portion are located on other side thereof.

### TECHNICAL FIELD

The present disclosure relates to an optical connector and an optical fiber with a connector. This application claims priority based on Japanese Patent Application No. 2017-015978 filed on Jan. 31, 2017 and all the contents described in the aforementioned Japanese application are incorporated herein.

### BACKGROUND ART

Patent Literature 1 discloses a technique for an optical fiber connector capable of converting polarity. This optical fiber connector includes two single-core connector portions which are inserted into an adapter. The optical fiber connector includes a latch portion which extends backward from a front end of each single-core connector portion. These latch portions are rotatable about the center axes of the single-core connector portions. These latch portions rotate by 180° during polarity conversion of switching the positions of two single-core connector portions with respect to the adapter.

Patent Literature 2 discloses a technique for an optical fiber assembly capable of converting polarity. This optical fiber assembly includes two single-core connector portions which are inserted into an adapter. The optical fiber assembly includes a latch portion which extends backward from a front end of each single-core connector portion. These single-core connector portions are respectively rotatable around their center axes. These single-core connector portions rotate by 180° during the polarity conversion of switching the positions of two single-core connector portions with respect to the adapter. Further, this optical fiber assembly further includes a flexible aim which releases an engagement while pressing the latch portion. This arm is rotatably attached to a rear portion of the optical fiber assembly. During the polarity conversion, the arm rotates by 180°.

### CITATION LIST

### Patent Literature

Patent Literature 1: International Publication No. 2012/151175

Patent Literature 2: US Patent Application Publication No. 2010/0220961

### SUMMARY OF INVENTION

An optical connector according to the disclosure is an optical connector which is connected to a receptacle or an adapter including a first connector inlet and a second connector inlet along a first direction, including: a first housing of which a front portion in the first direction is provided with a first optical connector portion and a second optical connector portion arranged in a second direction intersecting the first direction and respectively inserted into the first connector inlet and the second connector inlet; and a second housing which is attached to a rear portion of the first housing in the first direction in an attachable and detachable manner. The second housing includes a first latch portion and a second latch portion which are arranged in the second direction and extend from the rear portion toward the front portion so as to be respectively engage with the adapter or the receptacle in the first connector inlet and the second connector inlet, and the second housing is attachable to the rear portion in both of a state in which the first latch portion and the second latch portion are located on one side of the first housing in a third direction intersecting the first direction and the second direction and the first latch portion and the second latch portion are located on other side thereof. Additionally, the adapter is generally used to connect connectors and the receptacle is generally used to connect a connector to a device. Here, any of them includes a connector inlet.

### BRIEF DESCRIPTION OF DRAWINGS

FIG. 1 is a perspective view illustrating an appearance of an optical fiber with a connector.

FIG. 2 is a top view of the optical fiber with the connector.

FIG. 3 is a side view of the optical fiber with the connector.

FIG. 4 is a perspective view illustrating an appearance of a first housing and a boot.

FIG. 5 is a perspective view illustrating a second housing viewed from the obliquely front side.

FIG. 6 is a perspective view illustrating the second housing viewed from the obliquely rear side.

FIG. 7 is a side view of the second housing.

FIG. 8 is a top view of the second housing.

FIG. 9 is a perspective view illustrating a tab viewed from the obliquely upper side.

FIG. 10 is a perspective view illustrating the tab viewed from the obliquely lower side.

FIG. 11 is a perspective view illustrating an assembly state of the second housing and the tab viewed from the obliquely upper side.

FIG. 12 is a perspective view illustrating the assembly state of the second housing and the tab viewed from the obliquely lower side.

FIG. 13 is a cross-sectional view taken along a line XIII-XIII illustrated in FIG. 11.

FIG. 14 is a front view illustrating the assembly state of the second housing and the tab.

FIG. 15 is a perspective view illustrating an appearance of an adapter.

FIG. 16 is a diagram for describing a polarity conversion operation of an optical connector.

FIG. 17 is a diagram for describing the polarity conversion operation of the optical connector.

FIG. 18 is a diagram for describing the polarity conversion operation of the optical connector.

FIG. 19 is a diagram for describing the polarity conversion operation of the optical connector.

FIG. 20 is a diagram for describing the polarity conversion operation of the optical connector.

### DESCRIPTION OF EMBODIMENTS

### Problems to be Solved by Disclosure

A so-called dual optical connector having two single-fiber connector portions is used, for example, when transmitting and receiving lights are transmitted and received by separate optical fibers. When using such an optical connector, there is a need to switch the positions of two single-fiber connector portions for various reasons (so-called polarity conversion). During the polarity conversion, the position of the latch portion needs to be reversed by 180° (for example, see Patent Literatures 1 and 2). However, when a mechanism for reversing the latch portion becomes complex, the reliability of the optical connector is impaired.

The disclosure has been made in view of such problems and an object thereof is to provide an optical connector and an optical fiber with a connector capable of simplifying a mechanism for reversing a latch portion.

### Effect of Disclosure

According to the optical connector and the optical fiber with the connector of the disclosure, it is possible to simplify the mechanism for reversing the latch portion.

### Description of Embodiments

Next, the contents of the embodiment of the disclosure will be described. An optical connector according to an embodiment is an optical connector which is connected to a receptacle or an adapter including a first connector inlet and a second connector inlet along a first direction, including: a first housing of which a front portion in the first direction is provided with a first optical connector portion and a second optical connector portion arranged in a second direction intersecting the first direction and respectively inserted into the first connector inlet and the second connector inlet; and a second housing which is attached to a rear portion of the first housing in the first direction in an attachable and detachable manner. The second housing includes a first latch portion and a second latch portion which are arranged in the second direction and extend from the rear portion toward the front portion so as to be respectively engage with the adapter or the receptacle in the first connector inlet and the second connector inlet, and the second housing is attachable to the rear portion in both of a state in which the first latch portion and the second latch portion are located on one side of the first housing in a third direction intersecting the first direction and the second direction and the first latch portion and the second latch portion are located on other side thereof.

In this optical connector, the second housing is first detached from the first housing during the polarity conversion. Next, the second housing is reversed by 180°. As a result, a state in which the first latch portion and the second latch portion are located on one side of the first housing in the third direction is changed to a state in which the first latch portion and the second latch portion are located on other side thereof. Then, the second housing is attached to the first housing again while the positions of the first latch portion and the second latch portion are maintained. In the optical connector, the polarity can be changed only by such a simple operation. Further, the second housing which is attached to the first housing in an attachable and detachable manner includes two latch portions. Thus, the optical connector can simplify a configuration of reversing the latch portion as compared with the configurations described in Patent Literatures 1 and 2. Further, it is possible to improve the reliability of the optical connector.

In the optical connector, the second housing may surround the rear portion around a center axis of the first housing along the first direction. Accordingly, it is possible to highly accurately fix the second housing to the first housing. Thus, it is possible to improve the position accuracy of the first latch portion with respect to the first optical connector portion. Further, it is possible to improve the position accuracy of the second latch portion with respect to the second optical connector portion.

The optical connector may further include a boot which extends backward from a rear end of the first housing in the first direction and integrally accommodates an optical fiber extending from the first optical connector portion and an optical fiber extending from the second optical connector portion and the second housing may further include an opening through which the boot passes. Accordingly, when the second housing is detached from the first housing, the second housing is suspended from the boot or the optical fiber cable. Thus, it is possible to reduce the risk of dropping and losing the second housing.

In the optical connector, the boot may be relatively rotatable with respect to the opening around the center axis along the first direction and the boot may be able to pass through the opening when the boot is located at a first relative rotation position with respect to the opening and the boot is not able to pass through the opening when the boot is located at a second relative rotation position different from the first relative rotation position with respect to the opening. Accordingly, it is possible to suppress the second housing from being unintentionally detached from the first housing.

In the optical connector, the second housing may further include a first protrusion portion which is disposed between the first latch portion and the first optical connector portion and extends from the rear portion toward the front portion so as to be inserted into the first connector inlet along with the first optical connector portion and a second protrusion portion which is disposed between the second latch portion and the second optical connector portion and extends from the rear portion toward the front portion so as to be inserted into the second connector inlet along with the second optical connector portion. As a result, it is possible to reduce rattling by reducing a gap between the first connector inlet and the first connector and a gap between the second connector inlet and the second connector which are vertically asymmetric.

An optical fiber with a connector according to an embodiment includes any one of the above-described optical connectors and an optical fiber cable which includes an optical fiber extending from the first optical connector portion and an optical fiber extending from the second optical connector portion and extends backward from the rear end of the first housing in the first direction. This optical fiber with the connector includes any one of the above-described optical connectors. Thus, the optical fiber with the connector can simplify the mechanism for reversing the latch portion. Further, the optical fiber with the connector can improve the reliability of the optical connector.

### Detail of Embodiment

Detailed examples of the optical connector and the optical fiber with the connector of the embodiment of the disclosure will be described below with reference to the drawings. Additionally, the disclosure is not limited to the examples, but is shown by the scope of the claims. Then, it is intended to include all modifications within the scope of the claims and meaning equivalent to the scope of the claims. In the following description, the same reference numerals will be given to the same components in the description of the drawings and a redundant description will be omitted. Further, in the following drawings, an XYZ coordinate system is illustrated if necessary. A Z direction is a first direction of the embodiment. The Z direction indicates an insertion direction (a front and rear direction) of an optical connector with respect to an adapter or a receptacle. An X direction is a second direction of the embodiment. The X direction indicates a left and right direction of the optical connector. A Y direction is a third direction of the embodiment. The Y direction indicates an up and down direction of the optical connector. The X direction, the Y direction, and the Z direction intersect one another. In an example, the X direction, the Y direction, and the Z direction are orthogonal to one another.

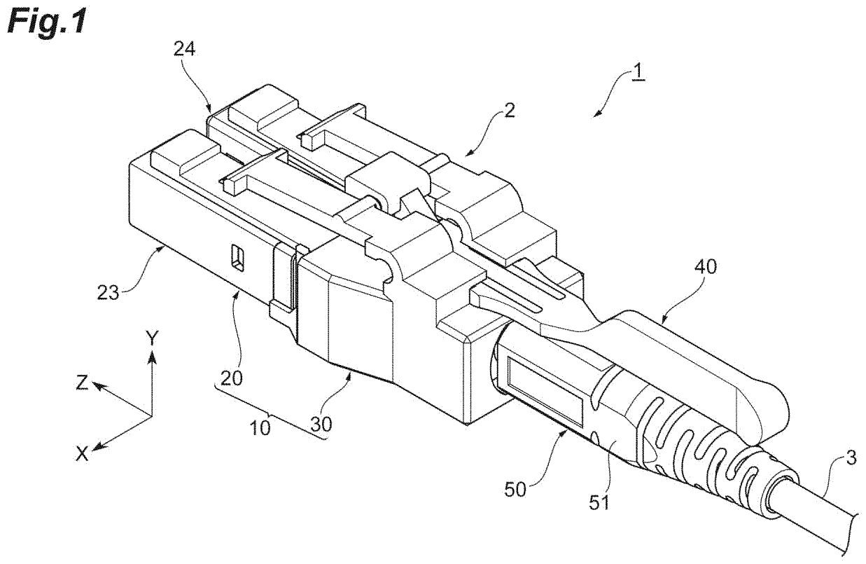

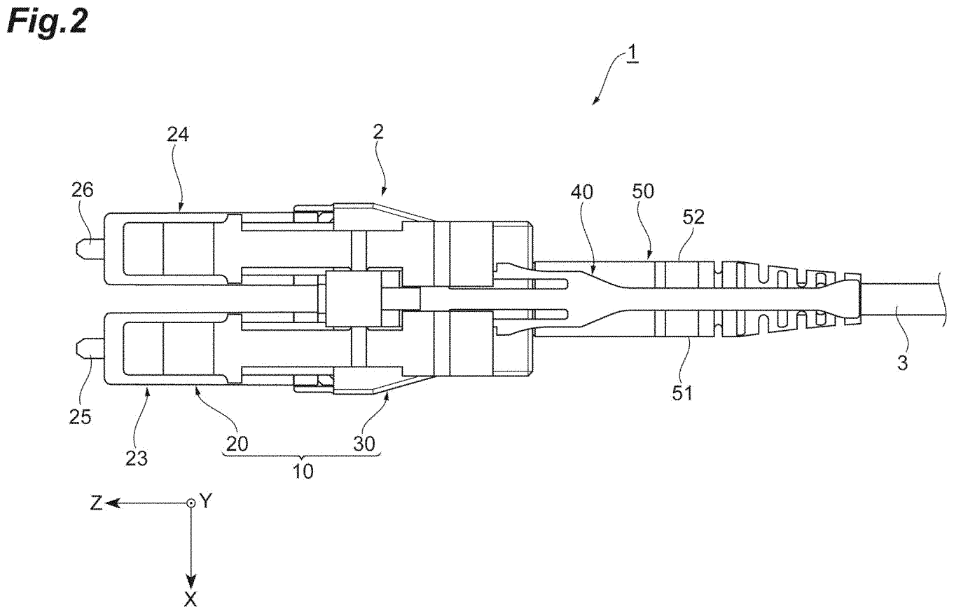

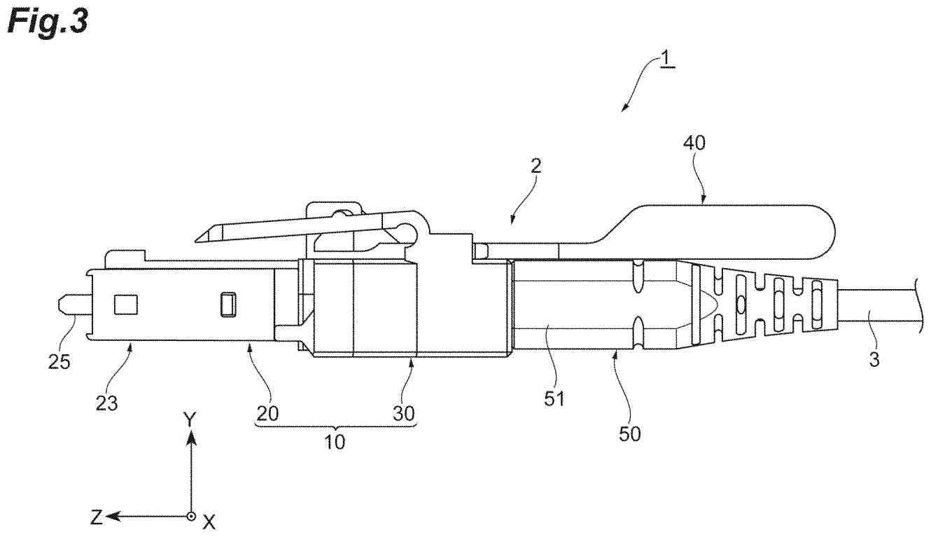

FIG. 1 is a perspective view illustrating a configuration of an optical fiber 1 with the connector according to an embodiment. FIG. 2 is a top view of the optical fiber 1 with the connector illustrated in FIG. 1. FIG. 3 is a side view of the optical fiber 1 with the connector illustrated in FIG. 1. As illustrated in FIGS. 1, 2, and 3, the optical fiber 1 with the connector includes an optical connector 2 and an optical fiber cable 3. The optical connector 2 includes a housing 10, a tab 40, and a boot 50. The housing 10 includes a first housing 20 and a second housing 30.

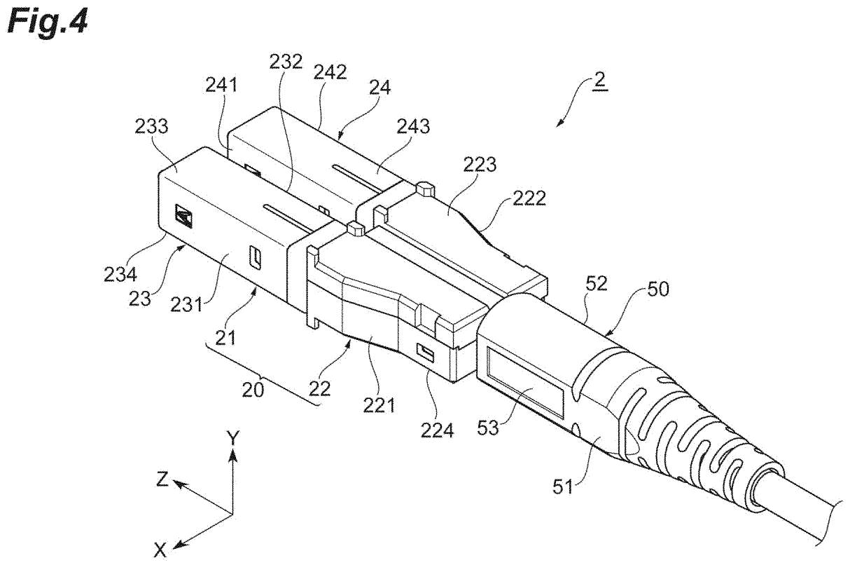

FIG. 4 is a perspective view illustrating an appearance of the first housing 20 and the boot 50. The first housing 20 is formed of, for example, a resin material called polyetherimide (PEI). The first housing 20 includes a front portion 21 (a front housing) and a rear portion 22 (an inner housing) which are arranged in the Z direction. The first housing 20 extends forward and backward along the Z direction. Additionally, the front portion 21 and the rear portion 22 may be integrally molded with each other. Further, the front portion 21 and the rear portion 22 may be molded as separate components and may be integrally assembled.

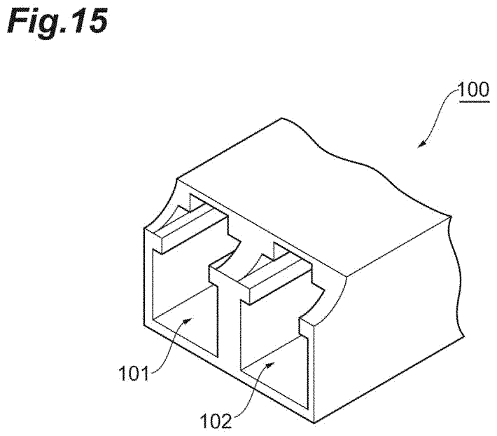

The front portion 21 includes a first optical connector portion 23 and a second optical connector portion 24. The first optical connector portion 23 and the second optical connector portion 24 are arranged in the X direction. The first optical connector portion 23 and the second optical connector portion 24 respectively extend forward and backward along the Z direction. The first optical connector portion 23 is a single-core optical connector. The first optical connector portion 23 is inserted into a first connector inlet 101 of an adapter 100 illustrated in FIG. 15. The first optical connector portion 23 accommodates a single-core optical fiber and a ferrule 25 (see FIGS. 2 and 3) which holds a front end portion of the optical fiber. The second optical connector portion 24 is a single-core optical connector. The second optical connector portion 24 is inserted into a second connector inlet 102 of the adapter 100 illustrated in FIG. 15. The second optical connector portion 24 accommodates another single-core optical fiber and another ferrule 26 (see FIG. 2) holding a front end portion of the optical fiber. The first optical connector portion 23 transmits, for example, upstream signal light. The second optical connector portion 24 transmits, for example, downstream signal light. The optical connector portions 23 and 24 respectively support the base end portions of the ferrules 25 and 26 so as to be movable in the front and rear direction. A metallic flange (not illustrated) is attached to the base end portions of the ferrules 25 and 26. This flange is urged forward by a coil spring. The front ends of the optical connector portions 23 and 24 respectively open. The proximal end portions of the ferrules 25 and 26 respectively protrude forward from these openings.

The shapes of the first optical connector portion 23 and the second optical connector portion 24 of the embodiment in a cross-section perpendicular to the Z direction are substantially square shapes. The first optical connector portion 23 includes a pair of side surfaces 231 and 232 which faces each other in the X direction and an upper surface 233 and a lower surface 234 which face each other in the Y direction. Similarly, the second optical connector portion 24 includes a pair of side surfaces 241 and 242 which faces each other in the X direction and an upper surface 243 and a lower surface which face each other in the Y direction. One side surface 232 of the first optical connector portion 23 and one side surface 241 of the second optical connector portion 24 face each other. The upper surface 233 of the first optical connector portion 23 and the upper surface 243 of the second optical connector portion 24 respectively face the same direction (the positive Y direction). The lower surface 234 of the first optical connector portion 23 and the lower surface of the second optical connector portion 24 respectively face the same direction (the negative Y direction).

The rear portion 22 of the first housing 20 is provided on the rear side in the Z direction with respect to the first optical connector portion 23 and the second optical connector portion 24. The rear portion 22 of the first housing 20 connects the base end portion of the first optical connector portion 23 and the base end portion of the second optical connector portion 24. The rear portion 22 is hollow. The rear portion 22 collectively accommodates the optical fibers respectively extending from the first optical connector portion 23 and the second optical connector portion 24. The shape of the rear portion 22 of the embodiment in a cross-section perpendicular to the Z direction is a substantially rectangular shape of which the X direction is the longitudinal direction. That is, the rear portion 22 includes a pair of side surfaces 221 and 222 which faces each other in the X direction and an upper surface 223 and a lower surface 224 which face each other in the Y direction. The pair of side surfaces 221 and 222 respectively includes inclined surfaces which are inclined in the X direction. A gap between the pair of side surfaces 221 and 222 is narrowed as it goes toward the rear end. Thus, a gap between the pair of side surfaces 221 and 222 at the rear end side of the rear portion 22 is narrower than a gap between the pair of side surfaces 221 and 222 at the front end side of the rear portion 22.

The boot 50 extends backward from the rear end of the first housing 20 in the Z direction. The boot 50 collectively accommodates the optical fiber extending from the first optical connector portion 23 and the optical fiber extending from the second optical connector portion 24. The boot 50 is a substantially cylindrical member. The boot 50 prevents an excessive bending stress from being generated in the optical fiber extending toward the outside of the first housing 20. The boot 50 is formed of a resin material (for example, thermoplastic elastomers (TPE)) softer than that of the first housing 20. The boot 50 is attached to the first housing 20 so as to be relatively rotatable around a center axis along the Z direction. Further, the outer peripheral surface of the boot 50 has a non-rotationally symmetrical shape around the center axis. In the embodiment, the outer peripheral surface of the boot 50 is provided with a pair of flat surfaces 51 and 52 which faces each other. The pair of flat surfaces 51 and 52 is parallel to each other. The pair of flat surfaces 51 and 52 extends along the Z direction. The flat surfaces 51 and 52 are provided with a mark 53 for easily seeing the rotation position of the boot 50.

As illustrated in FIGS. 1, 2, and 3, the optical fiber cable 3 extends backward from the rear end of the first housing 20 in the Z direction. The end portion of the optical fiber cable 3 is held by the boot 50. The optical fiber cable 3 includes the optical fiber extending from the first optical connector portion 23 and the optical fiber extending from the second optical connector portion 24.

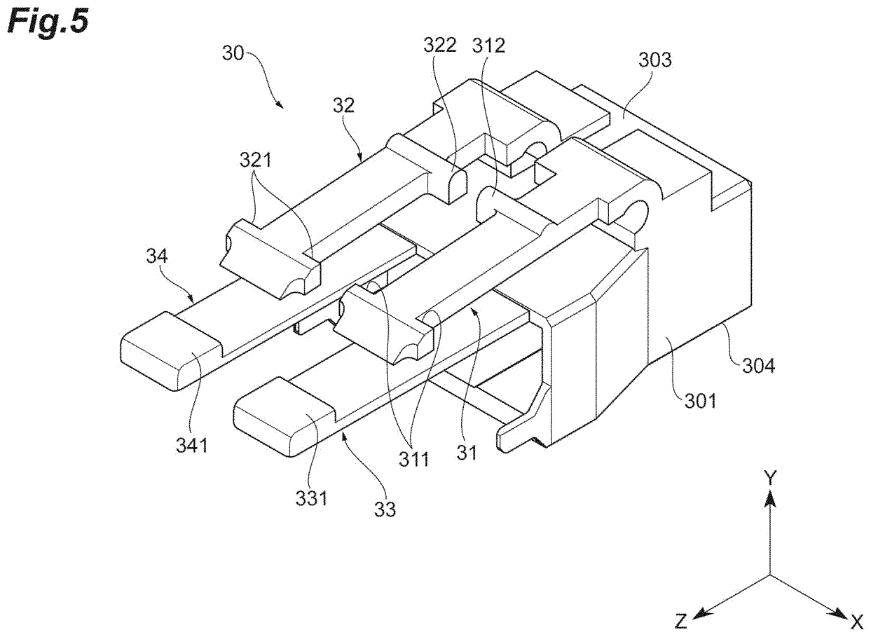

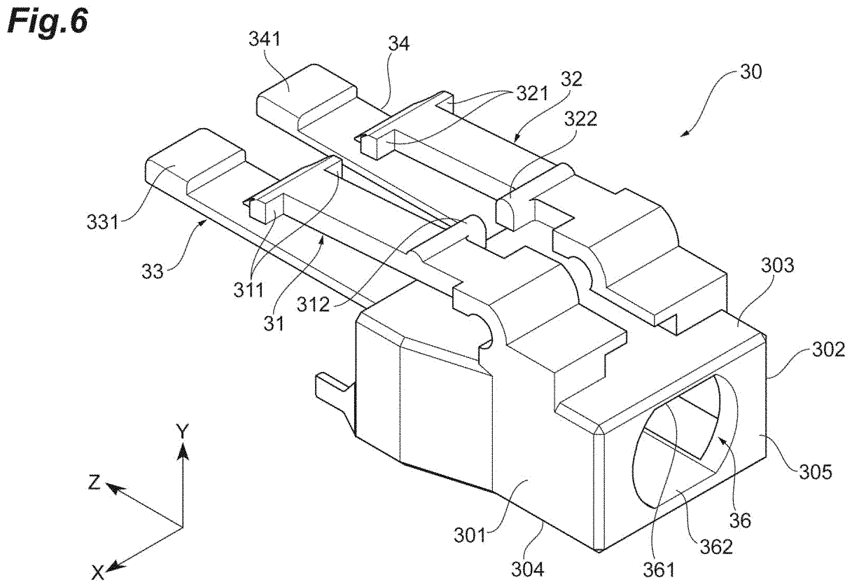

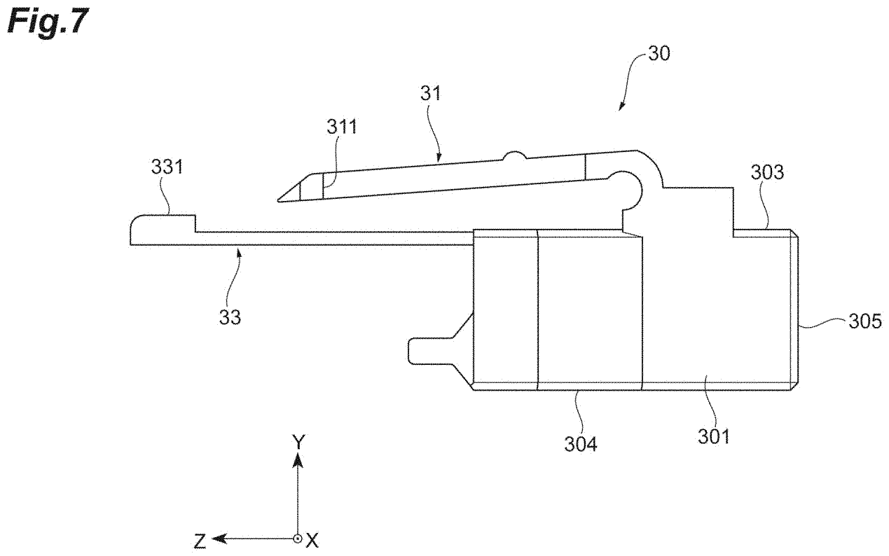

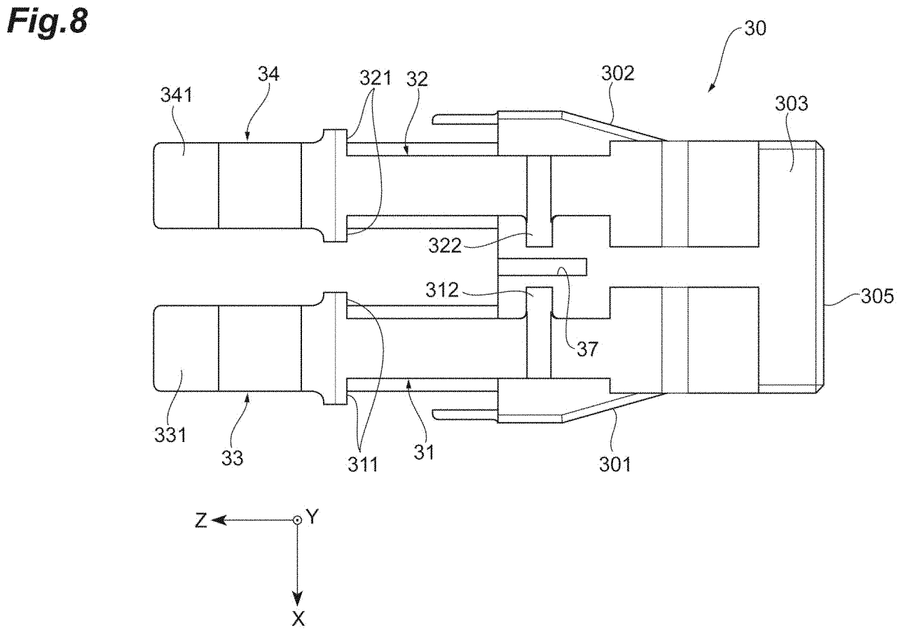

FIG. 5 is a perspective view illustrating the second housing 30 (the outer housing) viewed from the obliquely front side. FIG. 6 is a perspective view illustrating the second housing 30 viewed from the obliquely rear side. FIG. 7 is a side view of the second housing 30. FIG. 8 is a top view of the second housing 30. The second housing 30 is formed of, for example, a resin material called polyetherimide (PEI). The second housing 30 is attached to the rear portion 22 of the first housing 20 in an attachable and detachable manner so as to cover that portion. The shape of the second housing 30 of the embodiment in a cross-section perpendicular to the Z direction is a rectangular shape of which the X direction is the longitudinal direction. The second housing 30 surrounds the rear portion 22 around the center axis of the first housing 20 along the Z direction. Specifically, the second housing 30 includes a pair of side walls 301 and 302, an upper wall 303, a lower wall 304, and a rear end wall 305. The pair of side walls 301 and 302 respectively covers the pair of side surfaces 221 and 222 of the rear portion 22 of the first housing 20. The upper wall 303 covers the upper surface 223 (or the lower surface 224) of the rear portion 22. The lower wall 304 covers the lower surface 224 (or the upper surface 223) of the rear portion 22. The rear end wall 305 covers the rear end of the rear portion 22.

The second housing 30 includes a first latch portion 31 and a second latch portion 32. The latch portions 31 and 32 are arranged in the X direction and extend from the upper wall 303 of the rear portion 22 toward the front portion 21. The front ends of the latch portions 31 and 32 are provided with engagement portions 311 and 321. The engagement portions 311 and 321 respectively engage with the adapter 100 at the inside of the first connector inlet 101 and the inside of the second connector inlet 102 of the adapter 100 illustrated in FIG. 15. The latch portions 31 and 32 engage with the adapter 100 in the engagement portions 311 and 321 when the first optical connector portion 23 and the second optical connector portion 24 are respectively inserted from the first connector inlet 101 and the second connector inlet 102. With this configuration, the latch portions 31 and 32 prevent the unintended removal of the first optical connector portion 23 and the second optical connector portion 24. Additionally, the latch portions 31 and 32 receive a force generated by the tab 40 to be described later. Thus, the latch portions 31 and 32 respectively include bar-shaped portions 312 and 322 extending in the X direction. The bar-shaped portions 312 and 322 are located between the base end portions of the latch portions 31 and 32 (portions fixed to the upper wall 303) and the engagement portions 311 and 321.

The second housing 30 is attachable to the rear portion 22 of the first housing 20 even when the second housing is reversed by 180° around the center axis along the Z direction. In other words, the outer surface of the rear portion 22 of the first housing 20 and the inner surface of the second housing 30 have a rotationally symmetrical shape of 180° around the center axis along the Z direction. Thus, the second housing 30 is attachable to the rear portion 22 in both of a state in which the latch portions 31 and 32 are located on one side of the first housing 20 in the Y direction and a state in which the latch portions 31 and 32 are located on other side thereof.

The second housing 30 includes an opening 36 provided in the rear end wall 305. The opening 36 has a substantially circular shape through which the boot 50 passes. The opening 36 has a non-rotationally symmetrical shape around the center axis similarly to the outer peripheral surface of the boot 50. In the embodiment, the edge of the opening 36 is provided with a pair of linear portions 361 and 362. A gap between the pair of linear portions 361 and 362 is slightly larger than a gap between the pair of flat surfaces 51 and 52 of the boot 50. Further, the gap between the pair of linear portions 361 and 362 is smaller than the diameter of the outer peripheral surface in the front end of the boot 50 except for the pair of flat surfaces 51 and 52. Thus, when a relative rotation position of the boot 50 with respect to the opening is a rotation position (a first relative rotation position) in which the rotation positions of the pair of flat surfaces 51 and 52 match the rotation positions of the pair of linear portions 361 and 362, the boot 50 can pass through the opening 36. Thus, the second housing 30 can be detached from the first housing 20. Further, when a relative rotation position of the boot 50 is a rotation position (a second relative rotation position, for example, a position further rotated by 90° from the first relative rotation position) different from the first relative rotation position, the boot 50 cannot pass through the opening 36. Thus, the detachment of the second housing 30 from the first housing 20 is prevented.

The second housing 30 further includes a first protrusion portion 33 and a second protrusion portion 34. The first protrusion portion 33 is disposed between the first latch portion 31 and the first optical connector portion 23. The first protrusion portion 33 extends from the upper wall 303 of the rear portion 22 toward the front end of the first optical connector portion 23. The first protrusion portion 33 is inserted into the first connector inlet 101 (see FIG. 15) of the adapter 100 along with the first optical connector portion 23. The front end of the first protrusion portion 33 is provided with a convex portion 331 having a shape matching the cross-sectional shape of the first connector inlet 101. The second protrusion portion 34 is disposed between the second latch portion 32 and the second optical connector portion 24. The second protrusion portion 34 extends from the upper wall 303 of the rear portion 22 toward the front end of the second optical connector portion 24. The second protrusion portion 34 is inserted into the second connector inlet 102 along with the second optical connector portion 24. The front end of the second protrusion portion 34 is provided with a convex portion 341. The convex portion 341 has a shape matching the cross-sectional shape of the second connector inlet 102.

Again, FIGS. 1, 2, and 3 are referred. The tab 40 is a bar-shaped member. The tab 40 is formed of, for example, a resin material having elasticity called polycarbonate (PC). The tab 40 extends from the outer surface of the housing 10 (specifically, the surface of the upper wall 303 of the second housing 30) toward the rear side of the housing 10 along the Z direction. The tab 40 is attached to the upper wall 303 of the second housing 30 so as to be slidable in the Z direction.

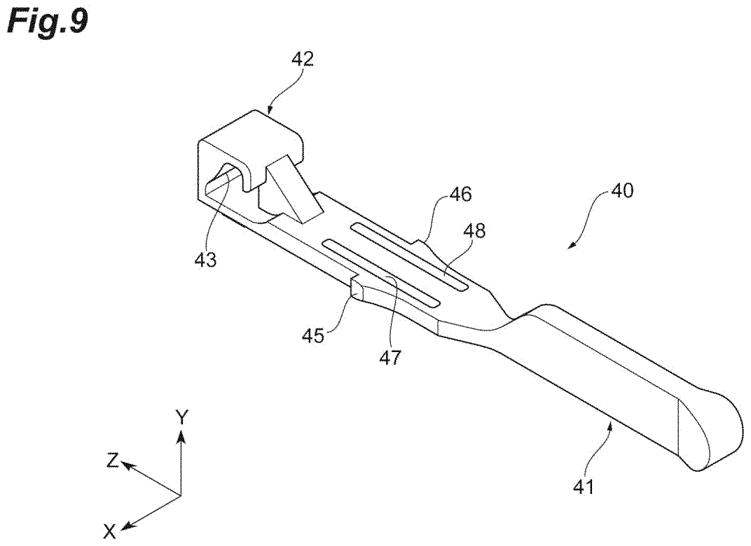

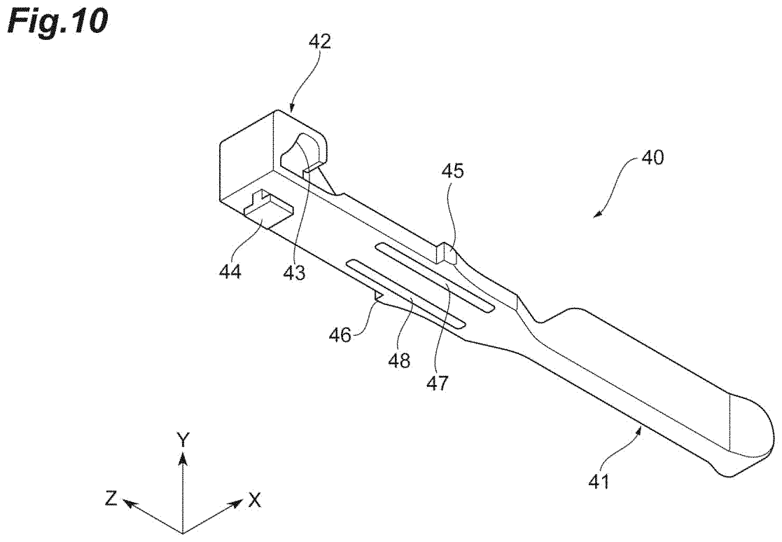

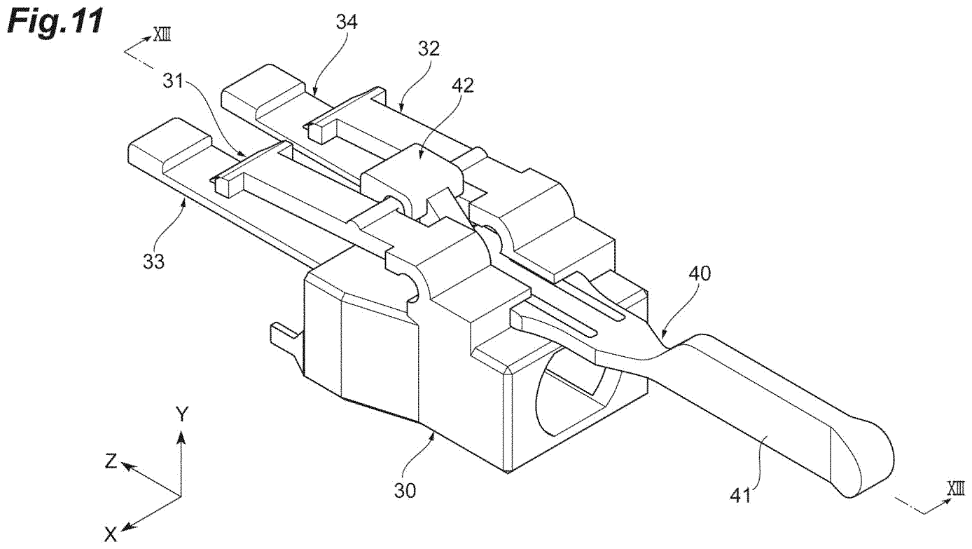

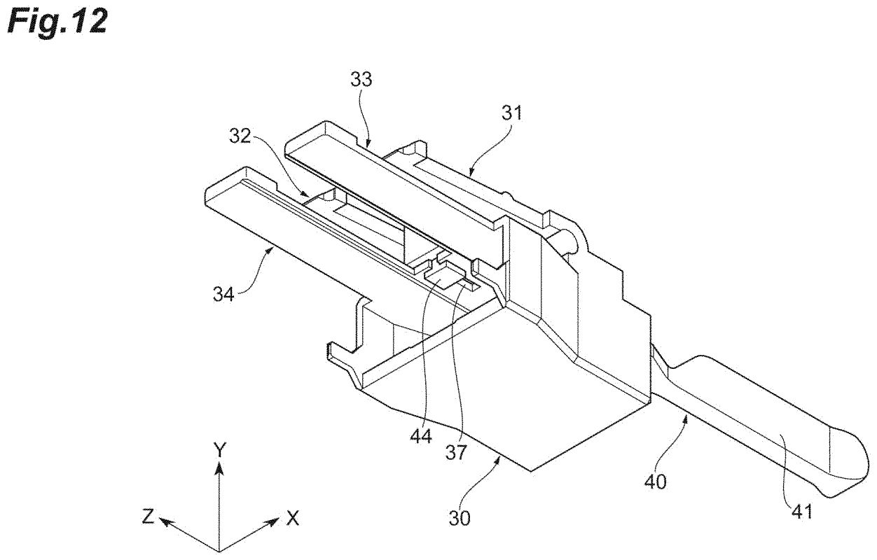

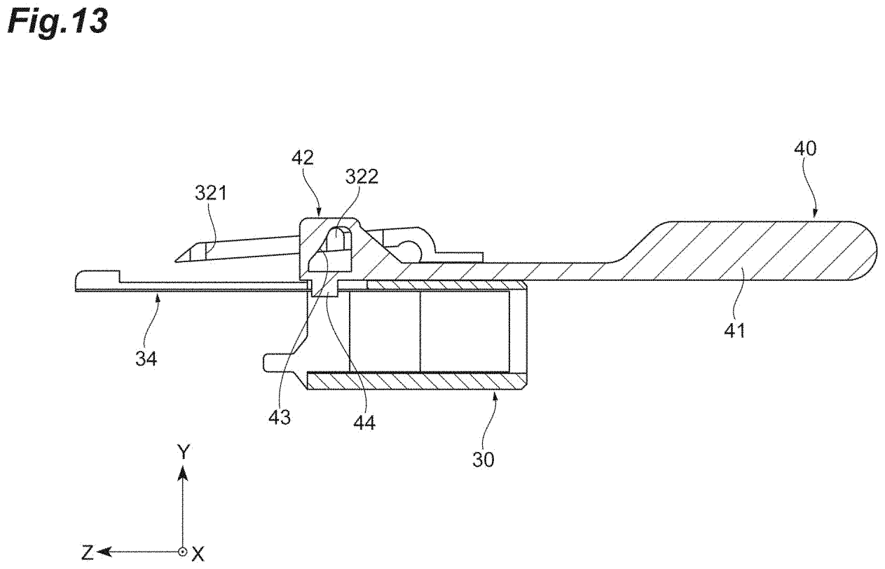

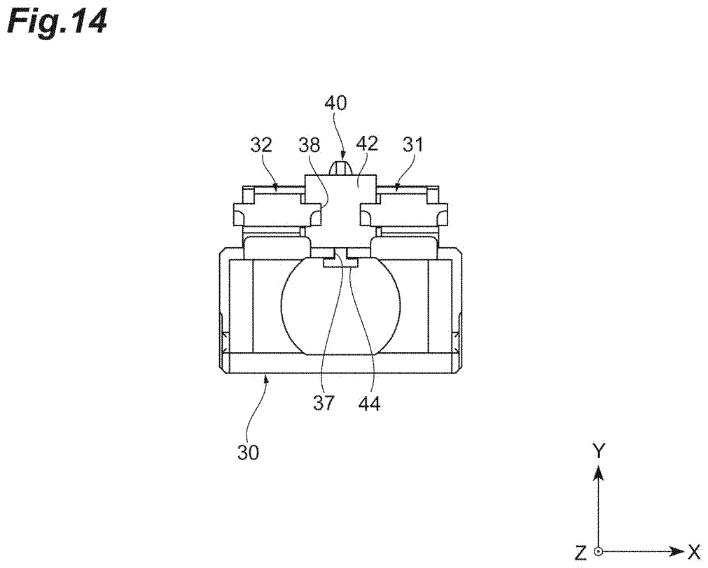

Here, FIG. 9 is a perspective view illustrating the tab 40 viewed from the obliquely upper side. FIG. 10 is a perspective view illustrating the tab 40 viewed from the obliquely lower side. FIG. 11 is a perspective view illustrating an assembly state of the second housing 30 and the tab 40 viewed from the obliquely upper side. FIG. 12 is a perspective view illustrating the assembly state of the second housing 30 and the tab 40 viewed from the obliquely lower side. FIG. 13 is a cross-sectional view taken along a line XIII-XIII illustrated in FIG. 11. FIG. 14 is a front view illustrating the assembly state of the second housing 30 and the tab 40 viewed from the positive Z direction.

As illustrated in FIGS. 9 and 10, the rear end portion of the tab 40 is provided with a grip portion 41 provided for an operator to pinch with fingers. The grip portion 41 is formed in a flat plate shape along the YZ plane for the operator to easily pinch with fingers. Further, the center portion or the front end portion of the tab 40 has a flat plate shape along the XZ plane so as to easily follow the upper surface of the housing 10. An annular portion 42 is provided at the front end portion of the tab 40. One inclined surface 43 is formed on the inner surface of the annular portion 42. This inclined surface 43 is inclined with respect to the Z direction. Specifically, the normal line of the inclined surface 43 is inclined toward the rear side in the Z direction with respect to the Y direction. Additionally, the inclined surface 43 may not be essentially flat. For example, in the embodiment, the inclined surface 43 is a slightly convex curved surface (a cylindrical surface having a curvature in the YZ plane).

As illustrated in FIG. 13, the inclined surface 43 contacts the bar-shaped portions 312 and 322 of the latch portions 31 and 32. Only the bar-shaped portion 322 is illustrated in FIG. 13, but the same applies to the bar-shaped portion 312. When the tab 40 slides backward, this inclined surface 43 also moves backward so that the bar-shaped portions 312 and 322 are pressed by the inclined surface 43. As a result, the latch portions 31 and 32 are pressed so that the engagement between the engagement portions 311 and 321 and the adapter 100 (see FIG. 15) is released. Additionally, the bar-shaped portions 312 and 322 of the embodiment are individually provided in the latch portions 31 and 32. However, in the bar-shaped portions 312 and 322, the bar-shaped portions of the latch portions 31 and 32 may be connected to each other.

Further, the tab 40 and the housing 10 of the embodiment include a slidable engagement mechanism. As an example, this mechanism includes a slit 37 (see FIGS. 12 and 14) which is formed in the second housing 30 and a protrusion 44 (see FIGS. 10 and 12 to 14) formed in the tab 40. The slit 37 is an elongated opening formed in the upper wall 303 of the second housing 30. The slit 37 extends in the Z direction. Further, as illustrated in FIG. 10, the protrusion 44 protrudes from the lower surface of the tab 40 toward the lower side in the Y direction (that is, the inside of the second housing 30). The cross-sectional shape of the protrusion 44 along the XY plane is an inverted T shape. Then, a T-shaped leg portion is inserted into the slit 37. With this configuration, the protrusion 44 engages with the slit 37 so as to be movable along the longitudinal direction of the slit 37.

Further, as illustrated in FIG. 6, the second housing 30 includes a narrow portion 38 (see FIG. 14) which sandwiches the tab 40 from a direction (in the embodiment, the X direction) intersecting the Z direction. Meanwhile, as illustrated in FIGS. 9 and 10, the tab 40 includes a pair of protrusions 45 and 46 which protrudes outward in the direction. The front ends of the protrusions 45 and 46 form contact surfaces which extend along the XY plane. The front ends of the protrusions 45 and 46 come into contact with the rear end of the narrow portion 38. The surfaces of the rear portions of the protrusions 45 and 46 constitute a part of the side surface of the tab 40. The surfaces of the rear portions of the protrusions 45 and 46 are inclined with respect to the Z direction so that the width of the tab 40 is gradually narrowed backward.

Further, the tab 40 further includes slits 47 and 48 which are formed between the pair of protrusions 45 and 46. In the embodiment, one slit 47 is provided near one protrusion 45 with respect to the center axis of the tab 40 along the Z direction. The other slit 48 is provided near the other protrusion 46 with respect to the center axis. These slits 47 and 48 pass between the upper surface and the lower surface of the tab 40. The slits 47 and 48 extend in the Z direction. The lengths of the slits 47 and 48 along the Z direction are longer than the lengths of the protrusions 45 and 46 in the same direction.

Next, a configuration of the adapter 100 connected to the optical connector 2 will be described. FIG. 15 is a perspective view illustrating an appearance of the adapter 100. The optical connector 2 is connected to the adapter 100 along the Z direction. The adapter 100 of the embodiment is a so-called dual adapter. The adapter 100 includes a first connector inlet 101 and a second connector inlet 102. As described above, the first optical connector portion 23 of the optical connector 2 is inserted into the first connector inlet 101. Further, the second optical connector portion 24 is inserted into the second connector inlet 102. Further, the latch portion 31 engages with the adapter 100 inside the first connector inlet 101. Further, the latch portion 32 engages with the adapter 100 inside the second connector inlet 102.

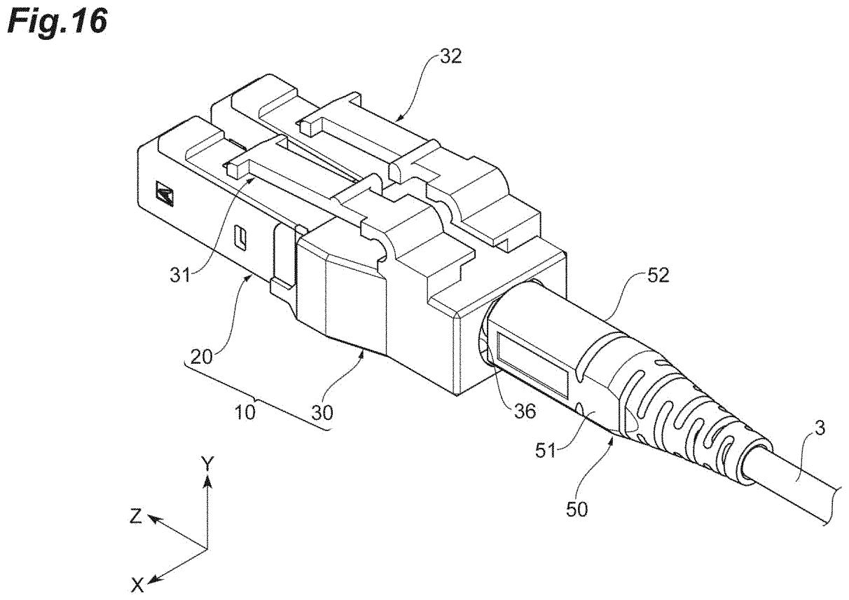

The polarity conversion operation of the optical connector 2 with the above-described configuration will be described with reference to FIGS. 16, 17, 18, 19, and 20. FIG. 16 illustrates a state in which the latch portions 31 and 32 of the second housing 30 are located on the upper surface side of the first housing 20. At this time, the second housing 30 is pressed from the rear side by the boot 50. As a result, the separation of the second housing 30 is prevented.

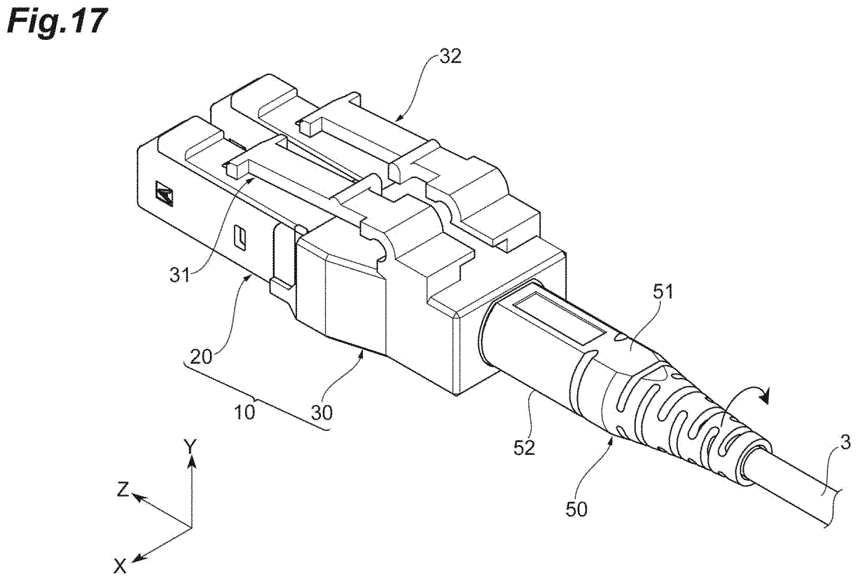

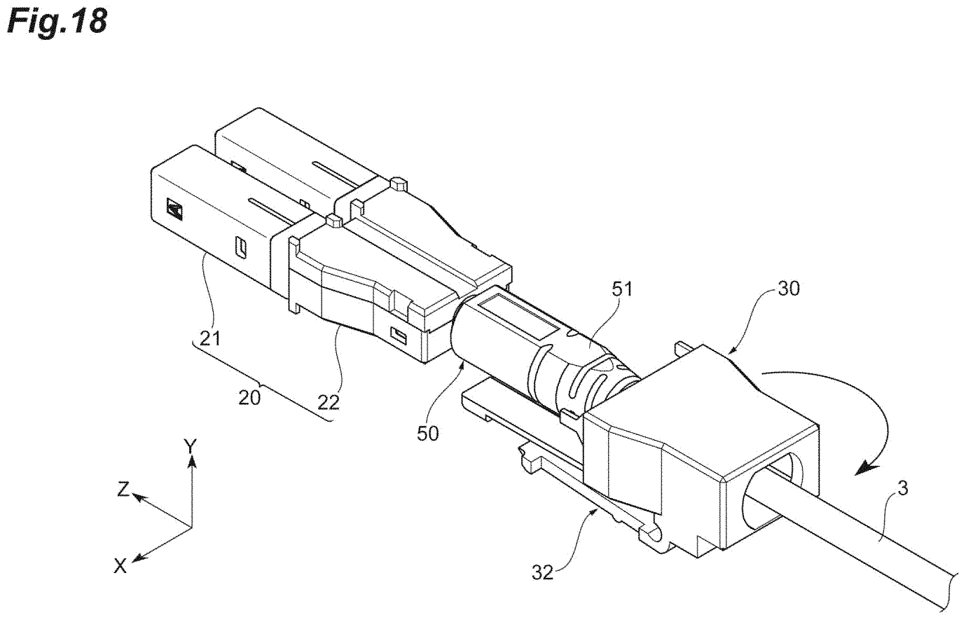

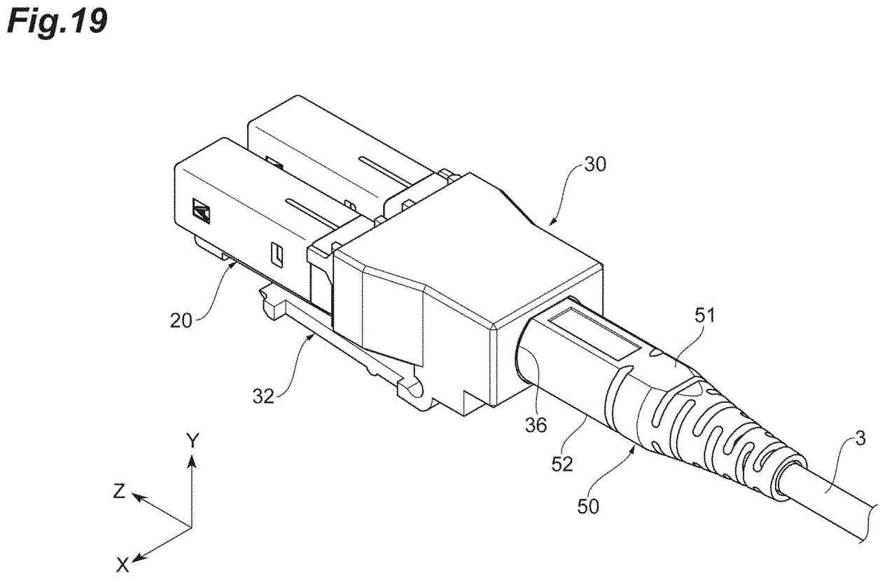

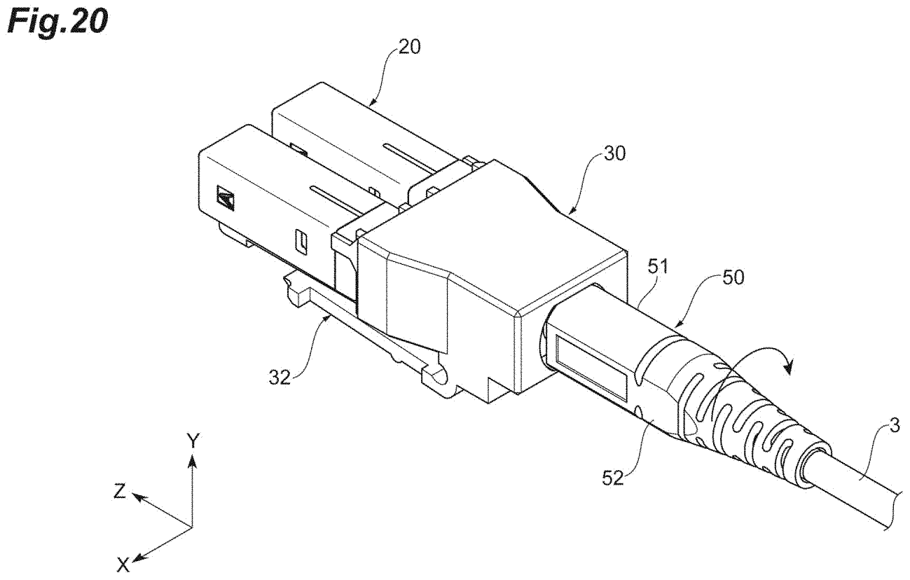

At the time of changing the polarity, the boot 50 is first rotated around the center axis as illustrated in FIG. 17. Accordingly, the positions of the pair of flat surfaces 51 and 52 of the boot 50 are made to match the pair of linear portions 361 and 362 (see FIG. 6) of the opening 36 of the second housing 30. Next, as illustrated in FIG. 18, the second housing 30 is detached from the first housing 20. That is, the second housing 30 is moved backward while the boot 50 is made to pass through the opening 36 of the second housing 30. Next, the second housing 30 is rotated around the center axis by 180°. Accordingly, the latch portions 31 and 32 are moved toward the lower surface side of the first housing 20. Next, as illustrated in FIG. 19, the second housing 30 is moved forward while the directions of the latch portions 31 and 32 are maintained. Accordingly, the second housing 30 is attached to the first housing 20 again. Finally, as illustrated in FIG. 20, the boot 50 is rotated again. Accordingly, the positions of the pair of flat surfaces 51 and 52 of the boot 50 are separated from the pair of linear portions 361 and 362 (see FIG. 6) of the opening 36 of the second housing 30. Accordingly, the second housing 30 is pressed from the rear side by the boot 50 so that the separation of the second housing 30 is prevented again. Additionally, it is desirable that the boot 50 be formed of a resin material harder than that of one used in a normal optical connector in order to maintain the strength at the time of fixing and rotating the second housing 30.

An effect obtained by the optical fiber 1 with the connector and the optical connector 2 of the above-described embodiment will be described. According to the optical fiber 1 with the connector and the optical connector 2, it is possible to change the polarity only by a simple operation illustrated in FIGS. 16, 17, 18, 19, and 20. Further, in the optical fiber 1 with the connector and the optical connector 2, the second housing 30 which is attached to the first housing 20 in an attachable and detachable manner includes two latch portions 31 and 32. Thus, the optical fiber 1 with the connector and the optical connector 2 can simplify a configuration for reversing the latch portion as compared with the configurations described in Patent Literatures 1 and 2. Further, the optical fiber 1 with the connector and the optical connector 2 can improve the reliability of the optical connector 2.

Further, as in the embodiment, the second housing 30 may surround the rear portion 22 around the center axis of the first housing 20 along the Z direction. Accordingly, the optical fiber 1 with the connector and the optical connector 2 can highly accurately fix the second housing 30 to the first housing 20. Further, the optical fiber 1 with the connector and the optical connector 2 can improve the position accuracy of the latch portions 31 and 32 with respect to the first optical connector portion 23 and the second optical connector portion 24.

Further, as in the embodiment, the second housing 30 may further include the opening 36 through which the boot 50 passes. Accordingly, when the second housing 30 is detached from the first housing 20, the second housing 30 is suspended from the boot 50 or the optical fiber cable 3. Thus, the optical fiber 1 with the connector and the optical connector 2 can reduce the risk of dropping and losing the second housing 30.

Further, as in the embodiment, the boot 50 is relatively rotatable with respect to the opening 36 around the center axis along the Z direction, the boot 50 may pass through the opening 36 when the boot 50 is located at the first relative rotation position with respect to the opening 36, and the boot 50 may not pass through the opening 36 when the boot 50 is located at a second relative rotation position different from the first relative rotation position. Accordingly, the optical fiber 1 with the connector and the optical connector 2 can suppress the second housing 30 from being unintentionally detached from the first housing 20.

Further, as in the embodiment, the second housing 30 may further include the first protrusion portion 33 which is disposed between the first latch portion 31 and the first optical connector portion 23 and is inserted into the first connector inlet 101 along with the first optical connector portion 23 and the second protrusion portion 34 which is disposed between the second latch portion 32 and the second optical connector portion 24 and is inserted into the second connector inlet 102 along with the second optical connector portion 24. Accordingly, the optical fiber 1 with the connector and the optical connector 2 can reduce rattling by reducing a gap between the first connector inlet 101 and the first optical connector portion 23 and a gap between the second connector inlet 102 and the second optical connector portion 24 which are vertically asymmetric.

The optical connector and the optical fiber with the connector according to the disclosure are not limited to the above-described embodiment and can be modified into various other forms. For example, in the above-described embodiment, as the mechanism for preventing the separation of the second housing 30, the opening 36 of the second housing 30 is provided with the pair of linear portions 361 and 362 and the boot 50 is provided with the pair of flat surfaces 51 and 52. However, the mechanism for preventing the separation of the second housing is not limited thereto. As the mechanism for preventing the separation of the second housing, various mechanisms capable of controlling the backward movement of the second housing by the rotation of the boot can be employed. Further, in the above-described embodiment, as the mechanism for engaging the second housing 30 with the tab 40, the slit 37 and the T-shaped protrusion 44 are exemplified. However, the mechanism is not limited to such a configuration. As a mechanism for engaging the second housing 30 with the tab 40, various configurations in which the tab slidably engages with the second housing can be employed. Further, in the embodiment, the second housing 30 surrounds the rear portion 22 around the center axis of the first housing 20. However, the second housing may have any shape as long as the second housing is attachable to and detachable from the rear portion of the first housing. Further, in the above-described embodiment, the tab 40 includes two slits 47 and 48 between the protrusions 45 and 46. However, one slit may be provided. Further, three or more slits may be provided. Further, in the above-described embodiment, a case in which the optical connector is connected to the adapter has been described. However, the optical connector of the disclosure may be connected to the receptacle having the same connection mechanism as that of the adapter.

### REFERENCE SIGNS LIST

1: optical fiber with connector, 2: optical connector, 3: optical fiber cable, 10: housing, 20: first housing, 21: front portion, 22: rear portion, 23: first optical connector portion, 24: second optical connector portion, 25, 26: ferrule, 30: second housing, 31: first latch portion, 32: second latch portion, 33: first protrusion portion, 34: second protrusion portion, 36: opening, 37: slit, 38: narrow portion, 40: tab, 41: grip portion, 42: annular portion, 43: inclined surface, 44: protrusion, 45, 46: protrusion, 47, 48: slit, 50: boot, 51, 52: flat surface, 100: adapter, 101: first connector inlet, 102: second connector inlet.

1. An optical connector which is connected to a receptacle or an adapter including a first connector inlet and a second connector inlet along a first direction, comprising:
a first housing of which a front portion in the first direction is provided with a first optical connector portion and a second optical connector portion arranged in a second direction intersecting the first direction and respectively inserted into the first connector inlet and the second connector inlet; and
a second housing which is attached to a rear portion of the first housing in the first direction in an attachable and detachable manner,
wherein the second housing includes a first latch portion and a second latch portion which are arranged in the second direction and extend from the rear portion toward the front portion so as to be respectively engage with the adapter or the receptacle in the first connector inlet and the second connector inlet, and
wherein the second housing is attachable to the rear portion in both of a state in which the first latch portion and the second latch portion are located on one side of the first housing in a third direction intersecting the first direction and the second direction and the first latch portion and the second latch portion are located on other side thereof.

2. The optical connector according to claim 1,
wherein the second housing surrounds the rear portion around a center axis of the first housing along the first direction.

3. The optical connector according to claim 1, further comprising:
a boot which extends backward from a rear end of the first housing in the first direction and integrally accommodates an optical fiber extending from the first optical connector portion and an optical fiber extending from the second optical connector portion,
wherein the second housing further includes an opening through which the boot passes.

4. The optical connector according to claim 3,
wherein the boot is relatively rotatable with respect to the opening around a center axis along the first direction, and
wherein the boot is able to pass through the opening when the boot is located at a first relative rotation position with respect to the opening and the boot is not able to pass through the opening when the boot is located at a second relative rotation position different from the first relative rotation position with respect to the opening.

5. The optical connector according to claim 1,
wherein the second housing further includes a first protrusion portion which is disposed between the first latch portion and the first optical connector portion and extends from the rear portion toward the front portion so as to be inserted into the first connector inlet along with the first optical connector portion and a second protrusion portion which is disposed between the second latch portion and the second optical connector portion and extends from the rear portion toward the front portion so as to be inserted into the second connector inlet along with the second optical connector portion.

6. An optical fiber with a connector comprising:
the optical connector according to claim 1; and
an optical fiber cable which includes an optical fiber extending from the first optical connector portion and an optical fiber extending from the second optical connector portion and extends backward from a rear end of the first housing in the first direction.
